(19) United States
(12) Patent Application Publication
(10) Pub. No.: US 2014/0116047 A1
(43) Pub. Date: May 1, 2014

(54) Tnaimou Wheel Heat Engine

(71) Applicant: Adil Tnaimou, Levittown, PA (US)

(72) Inventor: Adil Tnaimou, Levittown, PA (US)

(21) Appl. No.: 13/662,496

(22) Filed: Oct. 28, 2012

(51) Int. Cl. F03G 6/04; F02C 1/05

(52) U.S. Cl. 60/641.14; 60/682

(57) ABSTRACT

A heat engine system with a rotating wheel assembly. The wheel assembly rotates through an expansion zone and a contraction zone. The expansion zone heated. The contraction zone is not heated and may be actively cooled. Weights are supported by the wheel assembly. Each of the weights are movable from a first position that is a first distance from the wheel's center to a second position that is a farther second distance from that center. A temperature activated piston is coupled to each of the weights. Each of the temperature activated pistons move one of the plurality of weights between its first position and its second position as each temperature activated piston rotates on the wheel assembly through the expansion zone and the contraction zone. The movement of the weights dynamically alters the center of mass for the wheel assembly and causes it to turn.

### BACKGROUND OF THE INVENTION

1. Field of the Invention

In general, the present invention relates to mechanical heat engines that can be used to turn a generator and produce electricity. More particularly, the present invention relates to heat engines that are directly powered by solar energy.

2. Prior Art Description

Solar energy is plentiful, non-polluting and free. It is for these reasons that engineers have endeavored to create machines that are solar powered. Solar energy is commonly used as a heat source to power a variety of heat engines. For example, solar energy can be used to heat water into steam and run a steam engine. However, to concentrate solar power to produce significant volumes of steam requires the use of large reflectors spread over a wide area. As such, engines that require concentrated solar energy are impractical for many applications.

Solar energy, even if not concentrated by reflectors, is powerful enough to drive a variety of other heat engine types. One of the most common heat engines that can be powered by solar energy is a Stirling cycle engine. A Stirling cycle engine is a heat engine that operates by the cyclic compression and expansion of a working fluid. Solar power can be used to expand the working fluid. The expanding working fluid can then be used to move a piston and create mechanical work. Solar powered Stirling cycle engines are exemplified by U.S. Pat. No. 4,642,988 to Benson, entitled Solar Powered Free Piston Stirling Engine.

One of the simplest embodiments of a Stirling cycle engine is the wheel heat engine. A wheel heat engine contains a wheel with compartments along the periphery that contains working fluids. Different parts of the wheel are exposed to heat and/or cold. The heat is often solar energy. As the working fluid expands and contracts, the weight distribution within the wheel shifts and the wheel turns. Such prior art wheel heat engines are exemplified by U.S. Pat. No. 4,012,911 to Gulko, entitled Engine Powered By Low Boiling Liquid; U.S. Pat. No. 4,121,420 to Schur, entitled Gravity Actuated Thermal Motor; U.S. Pat. No. 6,240,729 to Yoo, entitled Converting Thermal Energy To Mechanical Motion, and U.S. Pat. No. 6,922,998 to Bittner, entitled Apparatus And Method For A Heat Engine. However, a problem associated with such prior art wheel heat engines is that they rotate slowly and produce only a small amount of torque for the size of the engine. A need therefore exists for an improved wheel heat engine that can provide more power than prior art wheel heat engines.

In U.S. Pat. No. 4,326,381 to Jensen, entitled Solar Engine, the National Aeronautic and Space Agency (NASA) developed a simple piston construction where a piston efficiently expands and contracts as it is cyclically exposed to sunlight. The Applicant has invented a way to improve the performance of wheel heat engines by incorporating such efficient solar expansion pistons into the structure of a wheel heat engine. The result is a wheel heat engine that runs faster and with more power than prior art attempts. The details of the improved design are described and claimed below.

### SUMMARY OF THE INVENTION

The present invention is a heat engine system that is preferably powered by solar energy. A wheel assembly is provided that has a central point around which the wheel assembly can turn. The wheel assembly rotates through an expansion zone and a contraction zone. A temperature differential is maintained between the expansion zone and the contraction zone. The expansion zone is heated. The contraction zone is not heated and may be actively cooled.

A plurality of weights are supported by the wheel assembly. Each of the weights is equal in mass. Furthermore, each of the weights are movable from a first position that is a first distance from the wheel's central point to a second position a further second distance from that central point. A temperature activated piston is coupled to each of the weights. Each of the temperature activated pistons moves one of the plurality of weights between its first position and its second position as each temperature activated piston rotates on the wheel assembly through the expansion zone and the contraction zone. The movement of the weights dynamically alters the center of mass for the wheel assembly. As a result, the wheel assembly will turn. The turning wheel assembly can then be used to perform work, such as generating electricity.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a schematic showing the major components of an exemplary embodiment of the present invention wheel heat engine;

FIG. 2 is a graph that plots displacement verses temperature and illustrates how the pistons move weights as a function of temperature;

FIG. 3 shows a system that contains multiple heat wheel engines; and

FIG. 4 is an alternate embodiment of a wheel heat engine that has magnetic components.

### DETAILED DESCRIPTION OF THE DRAWINGS

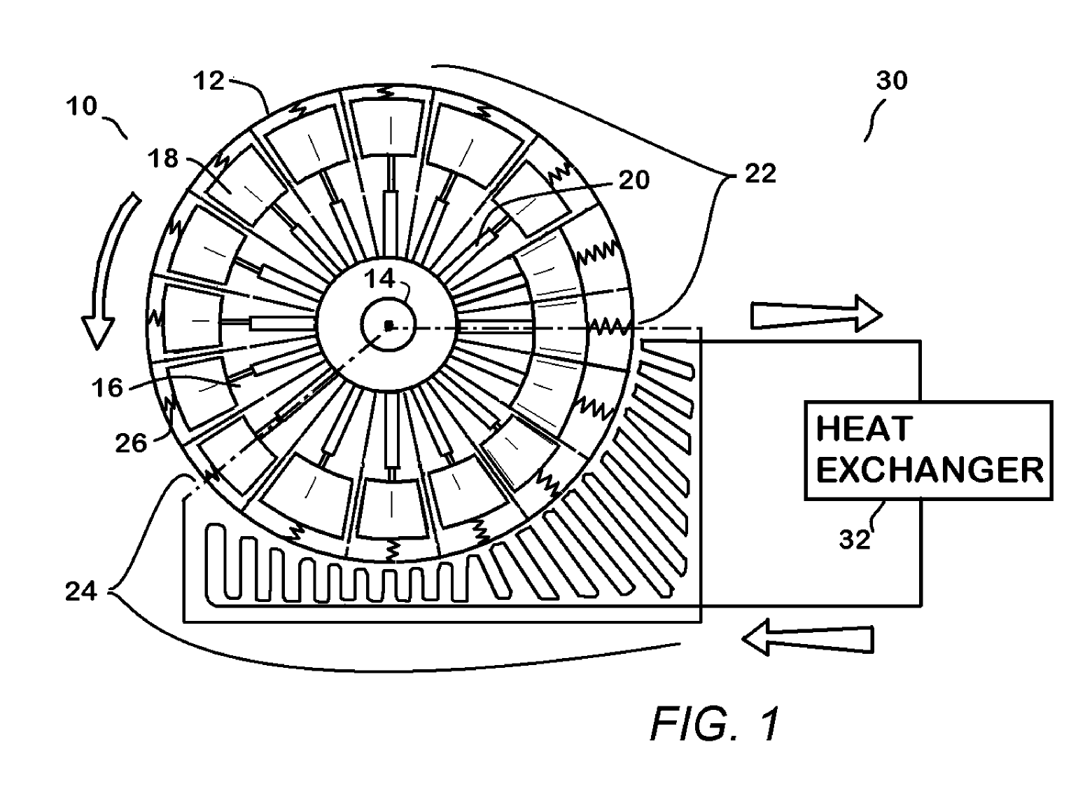

Referring to FIG. 1, there is presented a generalized schematic of a wheel heat engine 10. The wheel heat engine 10 includes a wheel assembly 12 that rotates around a central hub 14. The wheel assembly 12 is comprised of a plurality of vane subassemblies 16 that radially extend from the hub 14. Each of the vane subassemblies 16 includes a weight 18. The weight 18 is not stationary. Rather, each weight 18 can selectively move between a retracted position that is closer to the hub 14, and an extended position that is farther away from the hub 14.

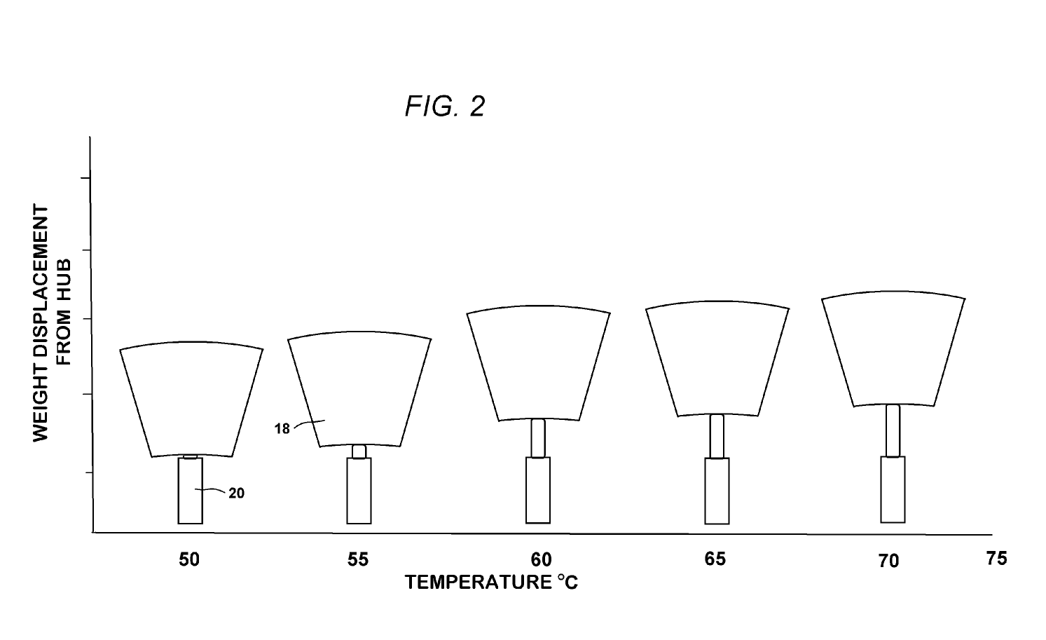

Referring to FIG. 2 in conjunction with FIG. 1, it can be seen that movement of the weight 18 in each vane subassembly 16 is primarily controlled by a piston 20. The piston 20 is filled with a working fluid that has either a high coefficient of thermal expansion or a liquid-to-vapor boiling point between 50 degrees Fahrenheit and 100 degrees Fahrenheit. Many working fluids for Stirling cycle engines have been developed in the prior art. Many such working fluids can be adapted for use in the present invention.

The wheel assembly 12 rotates through two zones. The two zones include an expansion zone 22 and a contraction zone 24. In the expansion zone 22, heat from an external source is transferred to the wheel assembly 12. In the contraction zone 24, heat is recovered from the wheel assembly 12.

The expansion zone 22 is preferably exposed to direct sunlight. As such, the vane subassemblies 16 are directly heated by solar energy when in the expansion zone 22. In the contraction zone 24, the vane subassemblies 16 are shielded from solar energy and can be otherwise cooled when they pass. Although some overlap may exist, most of the expansion zone 22 is located at an elevation along the wheel assembly 12 that is above the contraction zone 24.

As a vane subassembly 16 rotates into the expansion zone 22, its temperature rises. This raises the temperature of the working fluid in the piston 20. As a result, the piston 20 expands. As the piston 20 expands, it pushes the weight 18 within that vane subassembly 16 toward its extended position. When the piston 20 is fully extended, the weight 18 reaches its fully extended position and its farthest distance from the hub 14.

Conversely, when a vane subassembly 16 rotates out of the expansion zone 22 and into the contraction zone 24, the temperature of that vane subassembly 16 decreases. This lowers the temperature of the working fluid in the piston 20 and makes the piston 20 contract. As the piston 20 contracts, the weight 18 in that vane subassembly 16 is pulled toward the hub 14 and its retracted position. The movement of the weight 18 to its retracted position can be assisted by the use of one or more optional springs 26.

As the wheel assembly 12 turns, the various vane subassemblies 16 pass from the expansion zone 22 to the contraction zone 24, and back again. It will be understood that the weights 18 in the vane subassemblies 16 in the expansion zone 22 are, on average, farther from the hub 14 than are the weights 18 of the vane subassemblies 16 in the contraction zone 24. This creates a dynamic situation where the center of gravity for the wheel assembly 12 is no longer at the hub 14. Rather, the center of gravity for the wheel assembly 12 becomes shifted into the expansion zone 22. The result is that the wheel assembly 12 will spin about the hub 14. The rotation will continue for as long as the pistons 20 push the weights 18 in the expansion zone 22 farther way from the hub 14 then they do in the contraction zone 24. The hub 14 can then be connected to a generator to produce electricity or some other mechanism to power that mechanism.

The speed of rotation for the wheel assembly 12 is dependent upon a variety of factors, such as the mass of the weights 18 and the diameter of the wheel assembly 12. However, one of the most critical factors controlling the speed of rotation is the temperature differential between the expansion zone 22 and the contraction zone 24. The greater the temperature differential, the quicker the pistons 20 will expand and contact as they rotate through the zones 22, 24. The faster the pistons 20 expand and contract, the faster the weights 18 change positions. The faster the weights 18 change positions, the faster the wheel assembly 12 turns.

A significant temperature differential can be achieved between the expansion zone 22 and the contraction zone 24, simply by making the vane subassemblies 16 highly absorbent to solar radiation, exposing the vane subassemblies 16 to solar radiation in the expansion zone 22, and shielding the vane subassemblies 16 from sunlight in the contraction zone 24. Larger temperature differentials can also be obtained by actively cooling the contraction zone 24.

In FIG. 1, the wheel assembly 12 is part of a larger system 30 that contains a heat exchanger 32. The heat exchanger 32 can be a dedicated unit that is mounted in a shaded area, such as the north side of a building. The heat exchanger 32 can also be a secondary unit, such as a hot water heater, or a building heating unit that is capable of absorbing large amounts of heat. The wheel heat engine 10 is preferably positioned in a sunny location, such as the south side of a building. In viewing the overall system 30, it can be seen that the contraction zone 24 of the wheel heat engine 10 is actively cooled by circulating a coolant fluid, such as water or anti-freeze, through the contraction zone 24. The coolant fluid absorbs heat from the wheel assembly 12 as it cools the contraction zone 24. The coolant fluid is directed to the heat exchanger 32 using various pipe or tubing connections. The heat exchanger 32 cools the coolant fluid and recycles the coolant fluid back to the wheel heat engine 10.

The coolant can be circulated by a separate pump, wherein the pump is powered by the electricity being generated by the wheel heat engine 10. However, such an arrangement is not highly efficient. To make the system more efficient, the wheel assembly 12 itself can be used to move the coolant as it rotates. Otherwise, a mechanical pump can be directly powered by the wheel assembly 12, wherein the mechanical pump moves the coolant.

The wheel heat engine 10 described in FIG. 1 operates provided there is a temperature differential between the expansion zone 22 and the contraction zone 24. As originally described, the expansion zone 22 was exposed to sunlight in the ambient environment and the contraction zone 24 is shielded. However, this need not be the case. Under certain conditions, the wheel heat engine 10 will also run if the locations where the wheel assembly 12 are exposed and shielded are reversed.

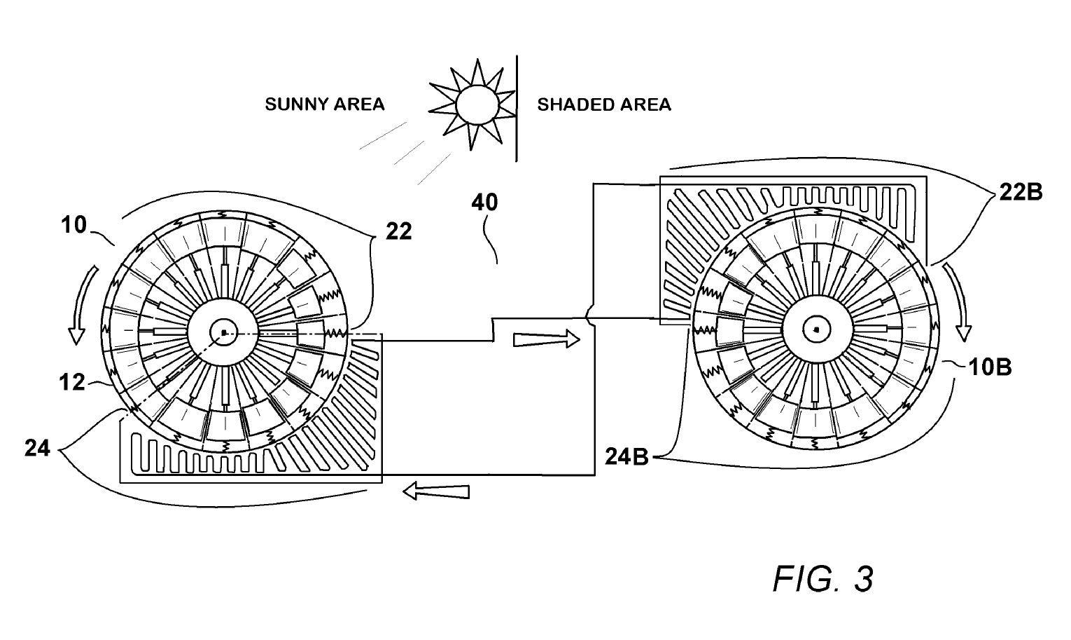

Referring to FIG. 3, the operation of the wheel heat engine in both modes can be explained in a combined system 40. In the system 40, two separate and distinct wheel heat engines 10, 10B are provided. The first wheel heat engine 10 is the same as described in FIG. 1. As such, the same nomenclature is used to describe the same parts. The second wheel heat engine 10B has the same wheel assembly 12B as was previously described. However, the exposed areas and the shaded areas surrounding the wheel assembly 12B differ. Both of the wheel heat engines 10, 10B have areas that are exposed to the ambient environment. Likewise, both wheel heat engines 10, 10B have areas that are shielded by a circulating coolant. It is only the position of the exposed areas and shielded areas that are reversed.

The first wheel heat engine 10 is placed in a sunny location so that its exposed area will receive direct sunlight. The exposed area therefore becomes the expansion zone 22 of the wheel heat engine 10. This causes the expansion zone 22 to become significantly warmer than the shielded area in which the coolant flows. It will therefore be understood that the first wheel heat engine 10 rotates in the manner previously described. As the coolant flows through the first wheel heat engine 10, the coolant cools the shielded area, which serves as the contraction zone 24. However, the coolant absorbs heat and increases in temperature.

The second wheel heat engine 10B is placed in a shaded area that does not receive direct sunlight. In the second wheel heat engine 10B, the positions of the exposed area and shielded area are reversed so that the shielded area is located mostly above the level of the exposed area. The shielded area is actively heated by the coolant incoming from the first wheel heat engine 10. The shielded area therefore becomes the expansion zone 22B since it is heated to a temperature that exceeds the ambient environment. Conversely, the exposed area is cooled by the shaded ambient air and the exposed area becomes the contraction zone 24B for the second wheel heat engine 10B. Provided a temperature differential exists between the expansion zone 22B and the contraction zone 24B, the second wheel heat engine 10B will also turn. Accordingly, the second wheel heat engine 10B is powered by the heat shed from the first heat wheel engine 10. The second wheel heat engine 10B can be used to generate power, pump coolant or otherwise do mechanical work.

In the overall system 40, it will be understood the first wheel heat engine 10 is the heat source for the second wheel heat engine 10B. Conversely, the second wheel heat engine 10B becomes the heat exchanger for the first wheel heat engine 10. The first wheel heat engine 10 and the second wheel heat engine 10B operate in the same manner. The only difference is the inversion of the exposed areas and shielded areas.

It will be understood that to make the system 40 more efficient, the wheel assembly 12 in the first wheel heat engine 10 will be made to absorb as much solar energy as possible. Conversely, the wheel assembly 12B in the second wheel heat engine 10B will be made with fins and other elements to emit as much heat to the surrounding environment as possible.

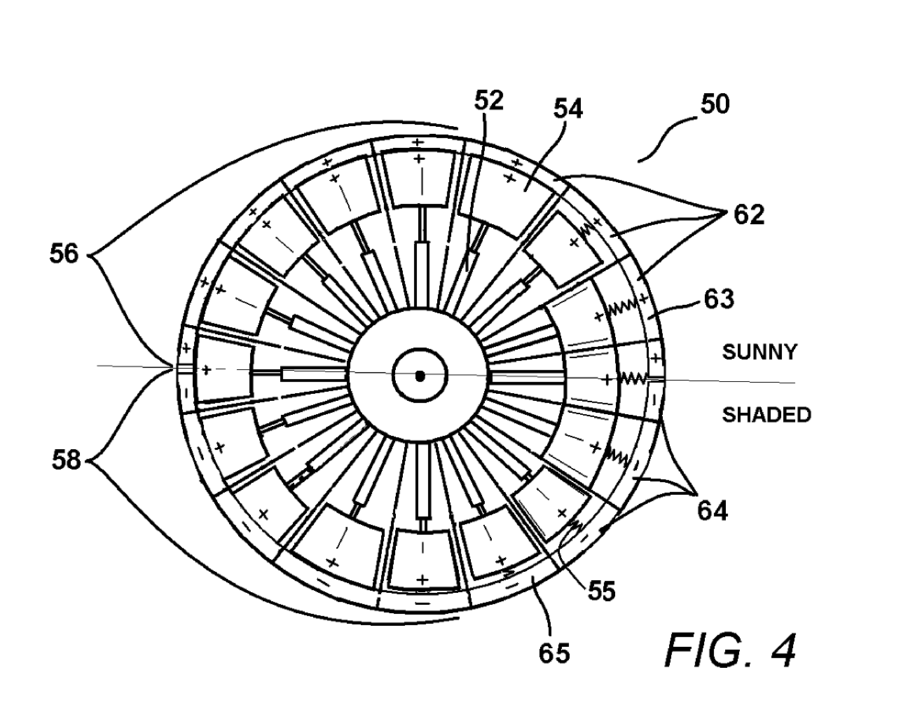

Referring to FIG. 4, an alternate embodiment of a heat wheel engine 50 is presented. The heat wheel engine 50 has pistons 52 and weights 54 of the type previously described. Likewise, the heat wheel engine 50 rotates through an expansion zone 56 and a contraction zone 58. The expansion zone 56 is heated by solar energy. In the expansion zone 56, the pistons 52 expand and move the weights 54 outwardly. The contraction zone 58 is shaded from solar energy or otherwise cooled. In the contraction zone 58, the pistons 52 contract and pull the weights 54 inwardly with the assistance of the springs 55.

The weights 54 are magnetized and/or contain magnets. As such, the weights 54 have magnetic poles. The poles are oriented so that the outer edge 60 of each weight 54 has the same polarity. In FIG. 4, the polarity at the outer edge 60 is shown as positive (+). However, the polarity can be reversed to negative. What is important is that the outer edge 60 of each weight 54 is the same.

Stationary magnet sets 62, 64 are provided in the contraction zone and the expansion zone. The stationary magnet set 62 in the expansion zone 56 is comprised of magnets 63 that have positive (+) poles facing the weights 54. Conversely, the stationary magnet set 64 in the contraction zone 58 is comprised of magnets 65 that have negative (−) poles facing the weights 54.

Since the weights 54 has a positive charge on their outer edges 60, the weights 54 are repulsed by the magnet set 62 in the expansion zone 56. This is especially true for the weights 54 that are displaced away from the hub, due to the small proximal distance between the magnetic poles. Likewise, the weights 54 are attracted to the magnet set 64 in the contraction zone 58. This is also especially true for the weights 54 displaced away from the hub, due to the small proximal distance between the magnetic poles. The magnetic attraction and repulsion acts to supplement gravity and help the wheel heat engine 50 rotate faster. The magnetic attraction and repulsion also enables the wheel heat engine 50 to operate in space or in other applications that have a weak gravity field.

The embodiment of the present invention presented is merely exemplary. It will be understood that a person skilled in the art can make many variations to the embodiments without departing from the intended scope of the invention. For instance, in the embodiment presented, a piston is used to move a weight away from the hub as temperatures increase. It will be understood that by reversing the piston, the piston can be used to move a weight toward the hub as temperatures increase. Provided a temperature difference exists between the expansion zones and the contraction zones, the wheel heat engine will still operate.

Likewise, it will be understood that more than one weight and more than one piston can be used in the various vane subassemblies of the wheel heat engines. Furthermore, multiple wheel heat engines can be joined together by coolant lines in sunny areas and shaded areas. All such embodiments are intended to be included within the scope of the present invention as defined by the claims.

What is claimed is:

1. A heat engine, comprising:
a wheel assembly having a hub around which said wheel assembly can turn, said wheel assembly rotating through a first zone and a second zone when turning, wherein a temperature differential exists between said first zone and said second zone;
a plurality of weights supported by said wheel assembly, wherein each of said weights is equal in mass and movable from a first position that is a first distance from said hub to a second position that is a different second distance from said hub;
a temperature activated piston coupled to each of said weights, wherein each said temperature activated piston moves one of said plurality of weights between said first position and said second position as each temperature activated piston rotates on said wheel assembly through said first zone and said second zone.

2. The heat engine according to claim 1, further including a cooling system for cooling said second zone.

3. The heat engine according to claim 2, wherein said cooling system includes a sun shield.

4. The heat engine according to claim 2, wherein said cooling system includes a coolant circulated through at least part of said second area.

5. The heat engine according to claim 4, further including a heat exchanger for cooling said coolant.

6. The heat engine according to claim 1, wherein said first position and said second position of each of said plurality of weights both lay on common lines that are radiant from said hub.

7. The heat engine according to claim 1, further including at least one spring for each of said plurality of weights that biases said weights toward said hub.

8. The heat engine according to claim 1, wherein each of said weights has magnetic poles and wherein said first zone and said second zone have opposite magnetic polarities.

9. A heat engine powered by solar energy, comprising:
a wheel assembly having a central point around which said wheel assembly can turn;
an expansion zone heated by the solar energy;
a contraction zone shielded from said solar energy, wherein said wheel assembly rotates through said expansion zone and said contraction zone when turning;
a plurality of weights supported by said wheel assembly, wherein each of said weights is equal in mass and is movable from a first position a first distance from said central point to a second position a farther second distance from said central point;
a temperature activated piston coupled to each of said weights, wherein each said temperature activated piston moves one of said plurality of weights between said first position and said second position as each temperature activated piston rotates on said wheel assembly through said expansion zone and said contraction zone.

10. The heat engine according to claim 9, further including a cooling system for cooling said contraction zone.

11. The heat engine according to claim 10, wherein said cooling system includes a coolant circulated through at least part of said contraction zone.

12. The heat engine according to claim 11, further including a heat exchanger for cooling said coolant.

13. The heat engine according to claim 9, wherein said weights have magnetic poles, and wherein said contract zone and said expansion zone have opposite magnetic polarities.

14. The heat engine according to claim 9, further including at least one spring for each of said plurality of weights that biases said weights toward said central point.

15. A system, comprising:
a first heat engine having a first wheel assembly that rotates through a first expansion zone and a first contraction zone, wherein a temperature differential exists between said first expansion zone and said first contraction zone, and wherein said first heat engine contains temperature activated pistons that expand and contract as said first wheel assembly rotates through said first expansion zone and said first contraction zone, therein causing said first wheel assembly to spin;
a second heat engine having a second wheel assembly that rotates through a second expansion zone and a second contraction zone, wherein a temperature differential exists between said second expansion zone and said second contraction zone, and wherein said second heat engine contains temperature activated pistons that expand and contract as said second wheel assembly rotates through said second expansion zone and said second contraction zone, therein causing said second wheel assembly to spin;
coolant that circulates between said first contraction zone and said second expansion zone, wherein said coolant absorbs heat in said first contraction zone and releases heat in said second expansion zone.

16. The system according to claim 15, wherein said temperature activated pistons move weights as said temperature activated pistons expand and contract.

17. The system according to claim 15, wherein said first expansion zone is exposed to direct sunlight and is heated by said sunlight.

18. The system according to claim 17, wherein said second contraction zone is shaded from direct sunlight.
